(19) United States
(12) Patent Application Publication
(10) Pub. No.: US 2022/0142070 A1
(43) Pub. Date: May 12, 2022

(54) Self-Watering Container

(71) Applicant: Yuvette Underwood, Columbus, GA (US)

(72) Inventor: Yuvette Underwood, Columbus, GA (US)

(21) Appl. No.: 17/096,671

(22) Filed: Nov. 12, 2020

(51) Int. Cl. A01G 27/06; A01G 9/02

(52) U.S. Cl. CPC A01G 27/06; A01G 9/02

(57) ABSTRACT

A self-watering container can include an outer wall being substantially waterproof, an inner wall being substantially porous, the inner wall defining a growing medium cavity, and the inner wall and outer wall defining a cylindrical water cavity in hydraulic communication with the growing medium cavity, and, a growing medium support mesh, the growing medium support mesh being configured to rest against the inner wall and receive moisture from the cylindrical water cavity through the substantially porous inner wall.

### FIELD OF THE INVENTION

The present subject matter relates generally to maintaining plants, and more particularly, to containers with self-watering features configured to promote healthy plants.

### BACKGROUND OF THE INVENTION

Plants grown in containers must be watered frequently to maintain appropriate moisture content within soil or mediums supporting plant growth. Different plants generally have different watering needs, and sometimes plants need consistent moisture absent overwatering or “drowning” of root systems. Additionally, different plants generally have different soil or medium requirements, including drainage speed, accessibility to atmospheric oxygen, and nutrient availability.

Containers for supporting plant growth have been produced for many years, with typical materials for construction including terracotta, pottery, and hewn natural stone. While these materials allow for containment of a growing medium, they lack an appropriate feedback mechanism to ensure appropriate moisture content of the growing medium. Other materials such as plastic, fiber, glass, porcelain, and similar materials also lack moisture content feedback.

Conventional solutions to maintaining moisture content typically involve forming a small water reservoir immediately below the growing medium such that excess water may be slowly absorbed by the growing medium in an upward manner In some prior solutions, a wick or rope is in hydraulic communication between the medium and the reservoir beneath the medium.

While these solutions allow slow absorption of water into the growing medium, they do not take into consideration the fouling or stagnation of water, leading to algae and fungal growth which can cause undesirable effects to both plant growth and health. Furthermore, these solutions do not clearly provide indication that additional water is needed. Moreover, these solutions lack an easy cleaning methodology due to the need to clean ropes, wicks, and several other portions of the container systems.

As a result, further improvements in containers for plant growth may be desirable. In particular, it would be advantageous to provide a self-watering container that addresses at least some of these drawbacks.

BRIEF DESCRIPTION OF THE INVENTION

Aspects and advantages of the invention will be set forth in part in the following description, or may be obvious from the description, or may be learned through practice of the invention.

According to some aspects, a self-watering container can comprise an outer wall being substantially waterproof and an inner wall being substantially porous. The inner wall can define a growing medium cavity, and the inner wall and outer wall can define a cylindrical water cavity in hydraulic communication with the growing medium cavity. The self-watering container can also comprise a growing medium support mesh, the growing medium support mesh being configured to rest against the inner wall and receive moisture from the cylindrical water cavity through the substantially porous inner wall.

According to some aspects, the outer wall is formed of plastic or ceramic.

According to some aspects, the inner wall is formed of the same material as the outer wall.

According to some aspects, the inner wall is formed of a different material as the outer wall.

According to some aspects, the inner wall is formed of plastic or ceramic.

According to some aspects, the self-watering container further comprises a base member, the base member defining a bottom portion of the growing medium cavity.

According to some aspects, the self-watering container further comprises a central column formed on the base member.

According to some aspects, the central column is configured to be in hydraulic communication with the water cavity.

According to some aspects, the self-watering container further comprises at least one aperture formed through the base member.

According to some aspects, the self-watering container further comprises a saucer configured to catch water expelled through the at least one aperture.

According to at least one aspect, a self-watering container comprises a cylindrical outer wall being substantially waterproof, a cylindrical inner wall being substantially porous, the cylindrical inner wall defining a growing medium cavity, and the cylindrical inner wall and cylindrical outer wall defining a cylindrical water cavity in hydraulic communication with the growing medium cavity, and a growing medium support mesh, the growing medium support mesh being configured to rest against the cylindrical inner wall and receive moisture from the cylindrical water cavity through the substantially porous cylindrical inner wall.

According to some aspects, the cylindrical outer wall is formed of plastic.

According to some aspects, the cylindrical inner wall is formed of the same material as the cylindrical outer wall.

According to some aspects, the cylindrical inner wall is formed of a different material as the cylindrical outer wall.

According to some aspects, the cylindrical inner wall is formed of plastic.

According to some aspects, the self-watering container further comprises a base member, the base member defining a circular bottom portion of the growing medium cavity.

According to some aspects, the self-watering container further comprises a central column formed on the base member.

According to some aspects, the central column is configured to be in hydraulic communication with the water cavity.

According to some aspects, the self-watering container further comprises at least one aperture formed through the base member.

According to some aspects, the self-watering container further comprises a saucer configured to catch water expelled through the at least one aperture

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a perspective view of a self-watering container system, in accordance with some implementations;

FIG. 2 is an elevation view of a self-watering container, in accordance with some implementations;

FIG. 3 is a lateral cross section view of a self-watering container, in accordance with some implementations;

FIG. 4 is a top view of a self-watering container, in accordance with some implementations;

FIG. 5 is a detailed view of an interior portion of a self-watering container, in accordance with some implementations;

FIG. 6 is a detailed view of a sensing arrangement of a self-watering container, in accordance with some implementations;

FIG. 7 is a lateral cross section view of an alternative arrangement of a self-watering container, in accordance with some implementations;

FIG. 8 is a lateral cross section view of an alternative arrangement of a self-watering container, in accordance with some implementations;

FIG. 9 is a lateral cross section view of an alternative arrangement of a self-watering container, in accordance with some implementations;

FIG. 10 is a lateral cross section view of an alternative arrangement of a self-watering container, in accordance with some implementations;

FIG. 11 is a lateral cross section view of an alternative arrangement of a self-watering container, in accordance with some implementations;

FIG. 12 is a lateral cross section view of an alternative arrangement of a self-watering container, in accordance with some implementations; and

FIG. 13 is a lateral cross section view of an alternative arrangement of a self-watering container, in accordance with some implementations.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). Furthermore, as used herein, terms of approximation, such as “approximately” or “substantially,” refer to being within a ten percent margin of error.

Containers for supporting plant growth have been produced for many years, with typical materials for construction including terracotta, pottery, and hewn natural stone. While these materials allow for containment of a growing medium, they lack an appropriate feedback mechanism to ensure appropriate moisture content of the growing medium. Other materials such as plastic, fiber, glass, porcelain, and similar materials also lack moisture content feedback.

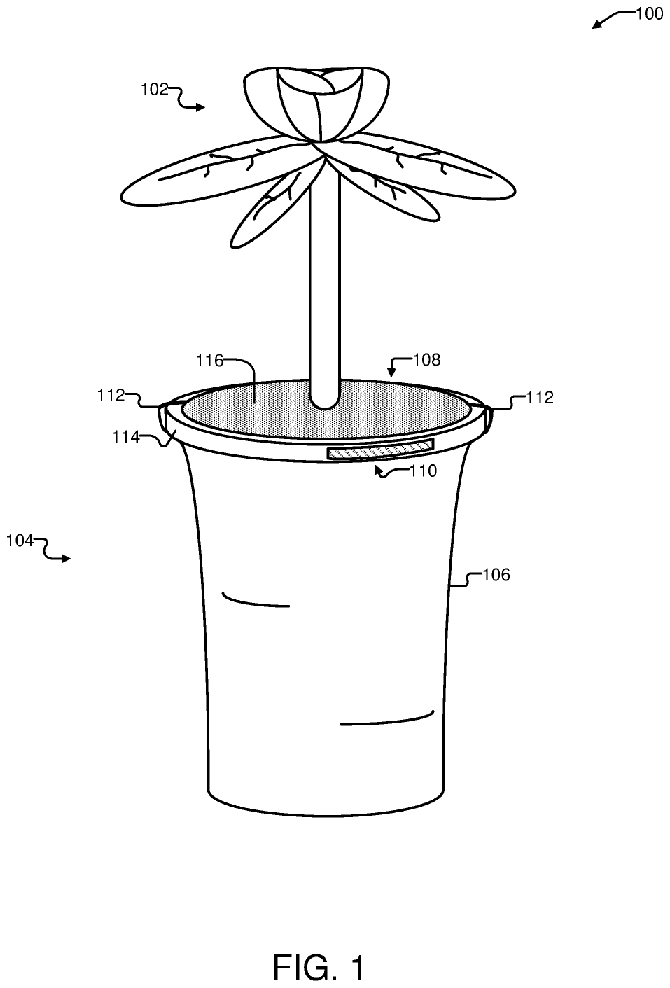

However, according to the systems and apparatuses presented herein, a self-watering container having appropriate feedback related to moisture content is provided. FIG. 1 is a perspective view of a self-watering container system, in accordance with some implementations. As shown, the system 100 can include a plant 102 whose growth is supported through a self-watering container 104. The plant 102 is intended to be illustrative of any plant, and is non-limiting.

The self-watering container 104 may include a substantially waterproof outer wall 106 with interior features 108 that define a growing medium cavity for supporting a growing medium 116. The outer wall may be formed of any substantially waterproof material.

As used herein, the term “substantially waterproof” refers to a material that can retain water without significant spillage of water. Suitable substantially waterproof materials can include, for example, high-fired or low-fired clay or terracotta, porcelain, wood, plastic, elastomers, some fabrics, metals, and other suitable materials. It is readily understood that virtually any material can be made substantially waterproof through application of paint, varnish, coatings, dips, sealants, and various treatments. Therefore, while the examples given herein relate to typical suitable materials, other materials may also be suitable.

The interior features of the self-watering container 104 are described more fully below, with reference to FIGS. 3, 5, and 7-13.

Turning back to FIG. 1, the growing medium 116 may include any suitable growing medium capable of supporting plant growth of the plant 102. Various growing mediums exist, and include gels, beads, fibers, soils, and combinations thereof. Other growing mediums include matrices of naturally occurring fibers, structures, and minerals such as rock wool. Still further, various forms and mixtures of materials may be suitable as growing mediums. Accordingly, any suitable growing medium may be applicable to the implementations described herein.

The self-watering container 104 may include a rim 114 configured to support and retain clips 112, opposite a base member 118 or base planar member 118. The clips 112 may be operative to retain a growing medium support mesh. The growing medium support mesh may be a flexible or rigid support mesh that conforms to the growing medium cavity and supports the growing medium 116. The growing medium support mesh may be formed of a suitable material, including elastomers, plastic, fabric, or other suitable materials. Furthermore, according to some implementations, the growing medium support mesh may be rigid or partially rigid. Still further, the growing medium support mesh may allow water, moisture, nutrients, and virtually any aqueous solution to pass from an exterior of the growing medium support mesh into the growing medium 116.

The rim 114 may also be configured to support feedback components 110. The rim 114 may be a defined rim having aesthetically pleasing lines, may be relatively undefined and simple, or any variant thereof. The rim 114 may be formed of the same material as the outer wall 106, or of a different material. Additionally, the rim 114 may protrude outward from the outer wall 106, or may be at a same or similar distance from a central axis defined by the outer wall 106.

The self-watering container 104 may be generally cylindrical as shown, or may have a different shape. Suitable shape may include cylindrical, square, rectangular, frustoconical, polygonal, frustrum or frustrum-like (including virtually any polygon arranged as a frustrum), and/or any suitable shape. Furthermore, although illustrated as a shape having a cross section with a shorter width than height, the same may be varied to a shallow container, tall container, wide container, and/or narrow container, depending upon a desired aesthetic, depth of growing medium 116, width of growing medium 116, average root depth required/desired, or any other suitable metric. Furthermore, organic shapes without rectilinear cross sections or measurements may also be applicable.

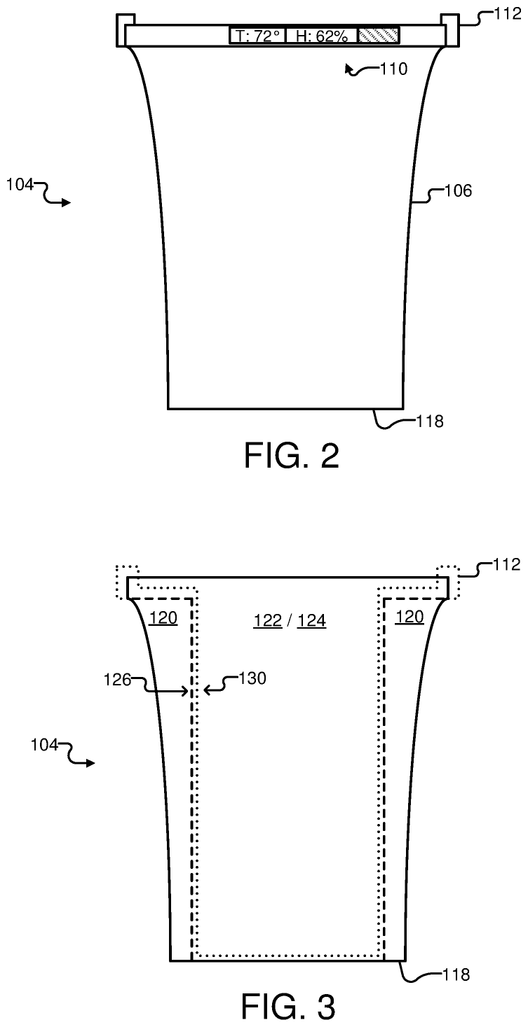

In general, the self-watering container 104 may be configured to allow water to permeate and flow into the growing medium 116 from an interior water cavity. The permeation and flow may be monitored through feedback components 110. For example, FIG. 2 is an elevation view of self-watering container 104, in accordance with some implementations.

As illustrated, the feedback components 110 may be visible from an exterior of the self-watering container 104. The feedback components 110 may include any suitable components, and may display a moisture content in any suitable format. For example, and without limitation, the moisture content may be displayed as a water level in the reservoir or water jacket (e.g., as a percentage, level, measure, or other value), a humidity level (e.g., as a percentage humidity or another value), a temperature and humidity (e.g., as a measure in degrees Fahrenheit or Celsius and percentage humidity or another value), and/or any other suitable form of moisture content.

As described above, the self-watering container 104 may provide feedback of moisture content and/or water level in a water reservoir or jacket. For example, FIG. 3 is a lateral cross section view of self-watering container 104, in accordance with some implementations.

The self-watering container 104 may include the outer wall 106 being substantially waterproof, the inner wall 126 being substantially porous, and the growing support mesh 130. The inner wall 126 defines a growing medium cavity 122 configured to house the growing medium support mesh 130. For example, the growing medium support mesh 130 may rest against the vertical inner wall 126. In this manner, water may flow through the substantially porous inner wall 126 and onto the growing medium support mesh 130 and an interior 124 of the growing medium support mesh.

Additionally, the inner wall 126 and outer wall 106 define a cylindrical water cavity 120 in hydraulic communication with the growing medium cavity 122. The interior 124 of the support mesh 130 may be complimentary to the cavity 122, and may receive the water. The hydraulic communication is facilitated by the inner wall 126 being substantially porous, while a growing medium may be deposited into the interior 124 of the growing medium support mesh 130 such that water flows until the growing medium has sufficient moisture content to slow water absorption.

For example, the growing medium may absorb water from the water cavity 120 at a relatively rapid rate until the growing medium has sufficient moisture to swell and/or at least partially block water flow from the pores of the inner wall 126 and/or support mesh 130. The growing medium itself holds these properties, and therefore, a size of the pores of the inner wall 126 may be chosen for relatively slow water flow, or relatively rapid water flow, and any other flow levels there-between.

According to one aspect, pores near an upper surface of the inner wall 126 may be larger than pores near the base portion 118. According to another aspect, the size of the pores may be similar. According to another aspect, the number or density of pores may differ depending upon a desired flow rate of an upper portion and lower portion of the self-watering container 104. Other adjustments to the size, number, density, and other aspects of the pores of the inner wall 126 may be applicable depending upon a particular implementation of the inner wall 126.

The growing medium support mesh 130 may be configured to rest against the inner wall 126 and receive moisture from the cylindrical water cavity 120 through the substantially porous inner wall. The growing medium support mesh 130 may be supported by clips 112 arranged about the rim 114.

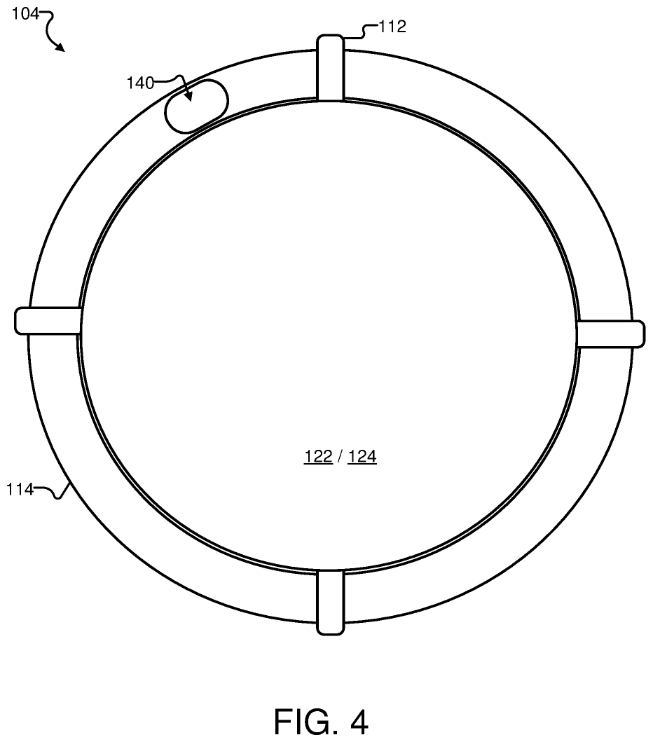

FIG. 4 is a top view of self-watering container 104, in accordance with some implementations. As shown, any number of clips 112 may be arranged about the rim 114 to support the growing medium support mesh 130. Furthermore, an orifice or watering aperture 140 may be formed into the container 104 such that the water cavity 120 may be filled from an exterior of the container 104, without disturbing the growing medium support mesh 130. Although not illustrated for clarity, the aperture 140 may include a cover, plug, or other suitable portion to obfuscate, seal, or otherwise close the aperture 140. For example, a cap, sliding cover, rubber plug, plastic panel, fabric panel, filter panel, or any other material may be used to cover the aperture 140. Additionally, a filtering medium may be included to limit fouling of the water cavity 120. However, a cover may also be omitted in some implementations.

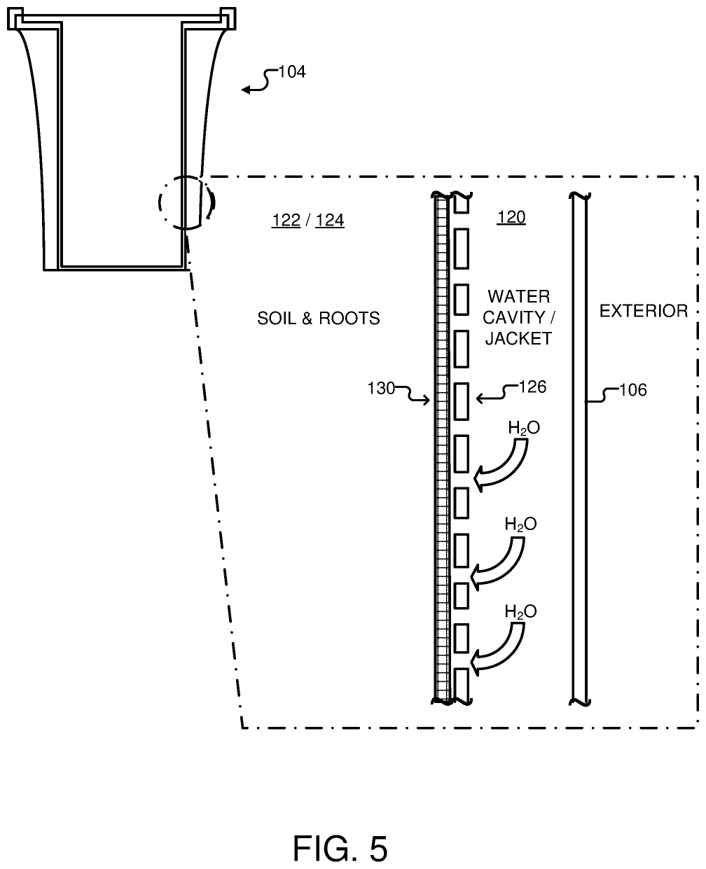

It is presented that although described as self-watering, the container 104 may also allow for feeding of a plant 102. For example, nutrient supplements may be mixed with water prior to filling through the aperture 140. In this manner, liquid, salts, powders, and other supplements may be routinely added to water to ensure plant health or growth. Similarly, medications, hormones, and other treatments may be added through the aperture 140 to treat plant health issues (e.g., nutrient deficiencies, insect damage, root nematodes, root diseases, plant diseases, etc.) or as prophylaxis (e.g., root strengthening supplements, flowering inhibitors or flowering promoters, insecticidal treatments, etc.). The self-watering, and, ostensibly, self-feeding, may be facilitated through the interaction between the inner wall 126, water cavity 120, and growing medium support mesh 130, as illustrated in FIG. 5.

FIG. 5 is a detailed view of an interior portion of self-watering container 104, in accordance with some implementations. The self-watering container 104 may include the outer wall 106 being substantially waterproof, the inner wall 126 being substantially porous, and the growing support mesh 130. The inner wall 126 defines the growing medium cavity 122 configured to house the growing medium support mesh 130. As shown in detail, the growing medium support mesh 130 may rest against the vertical inner wall 126. In this manner, water may flow through the substantially porous inner wall 126 and onto the growing medium support mesh 130 and the interior 124 of the growing medium support mesh.

Additionally, the inner wall 126 and outer wall 106 define the cylindrical water cavity 120 in hydraulic communication with the growing medium cavity 122. The interior 124 of the support mesh 130 may be complimentary to the cavity 122, and may receive the water. The hydraulic communication is facilitated by the inner wall 126 being substantially porous, while a growing medium, soil, and roots may be deposited into the interior 124 of the growing medium support mesh 130 such that water flows until the growing medium has sufficient moisture content to slow water absorption.

For example, the growing medium may absorb water from the water cavity 120 at a relatively rapid rate until the growing medium has sufficient moisture to swell and/or at least partially block water flow from the pores of the inner wall 126 and/or support mesh 130. The growing medium itself holds these properties, and therefore, a size of the pores of the inner wall 126 may be chosen for relatively slow water flow, or relatively rapid water flow, and any other flow levels there-between.

According to one aspect, pores near an upper surface of the inner wall 126 may be larger than pores near the base portion 118. According to another aspect, the size of the pores may be similar. According to another aspect, the number or density of pores may differ depending upon a desired flow rate of an upper portion and lower portion of the self-watering container 104. Other adjustments to the size, number, density, and other aspects of the pores of the inner wall 126 may be applicable depending upon a particular implementation of the inner wall 126.

The growing medium support mesh 130 may be configured to rest against the inner wall 126 and receive moisture from the cylindrical water cavity 120 through the substantially porous inner wall. Furthermore, as shown in detail, the water cavity 120 surrounds the support mesh 130 and inner wall 126. Thus, the water cavity 120 may have a central axis that is substantially collinear with a central axis of the inner wall 126, the support mesh 130, and the container 104. In this manner, the water cavity 120 may be referred to as a “water jacket.”

This water jacket provides several technical benefits including water flow to an upper portion of the growing medium support mesh 130, water flow to a central portion of the growing medium support mesh 130, and/or water flow to a bottom portion of the growing medium support mesh 130. Each of these water flow rates may be complimentary and occur simultaneously, or may be tailored for different flow rates through manipulation of the size, placement, and/or density of the pores of the inner wall 126. Furthermore, the size, placement, and/or density of the pores of the inner wall 126 may limit water flow such that overwatering is reduced or minimized Additionally, the size, placement, and/or density of the pores of the inner wall 126 may limit nutrient transfer to the growing medium such that over fertilization does not occur, is reduced, or is minimized This in turn promotes plant health and reduces the chances for “nutrient lock-out” and other frequent drawbacks to bottom-only water reservoirs.

In additional to the benefits of the arrangement of the support mesh 130, the inner wall 126, and the water cavity 120, feedback components 110 provide data to a consumer such that overwatering, overfertilization, and other issues may be avoided.

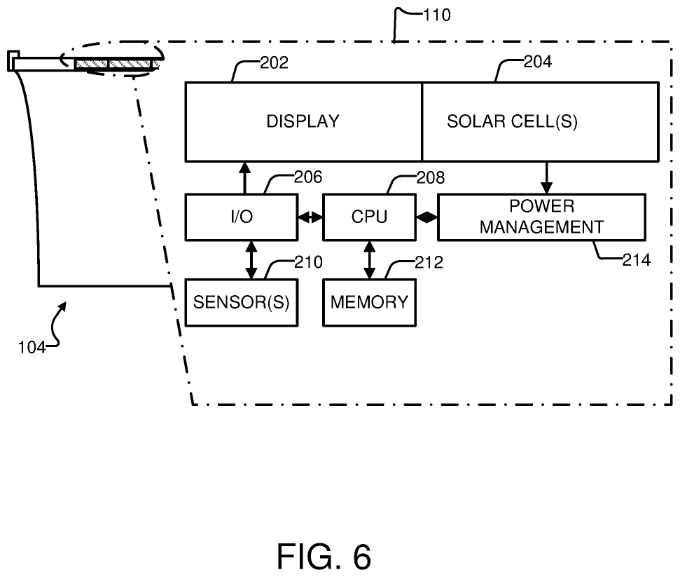

FIG. 6 is a detailed view of a sensing arrangement of feedback components 110 of self-watering container 104, in accordance with some implementations. As shown, the feedback components 110 may include a display 202, solar cells (or another power source) 204, input/output (I/O) 206, a computer processor 208, sensors 210, memory 212, and power management 214.

In general, the feedback components 110 are arranged similarly to a conventional computer architecture configured to perform methods of water sensing and/or moisture sensing feedback. For example, the computer architecture shown in FIG. 6 may be utilized to execute software components for providing the moisture feedback and/or related functionality.

In one illustrative configuration, one or more central processing units (“CPUs”) 208 operate in conjunction with a chipset or bus. The CPUs 208 may be standard programmable processors that perform arithmetic and logical operations necessary for the operation of the feedback components 110.

The CPUs 208 perform operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The chipset or bus provides an interface between the CPUs 208 and the remainder of the components. The chipset may provide an interface to a RAM or a computer-readable storage medium such as memory 212 for storing routines and other software components necessary for the operation of the feedback components 110 in accordance with the configurations described herein.

The memory 212 may be a mass storage device that provides non-volatile storage, volatile storage, or any combination thereof. The memory 212 may store system programs, application programs, other program modules, and data. The memory 212 may consist of one or more physical storage units.

The CPUs 208 may store data on the memory 212 by transforming the physical state of the physical storage units to reflect the information being stored. The specific transformation of physical state may depend on various factors, in different implementations of this description. Examples of such factors may include, but are not limited to, the technology used to implement the physical storage units, whether the memory 212 is characterized as primary or secondary storage, and the like.

For example, the CPUs 208 may store information to the memory 212 by issuing instructions to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The CPUs 208 may further read information from the memory 212 by detecting the physical states or characteristics of one or more particular locations within the physical storage units.

In addition to the memory 212, the CPUs 208 may have access to other computer-readable storage media to store and retrieve information, such as program modules, data structures, or other data. It should be appreciated by those skilled in the art that computer-readable storage media is any available media that provides for the non-transitory storage of data and that may be accessed by the CPUs 208.

By way of example, and not limitation, computer-readable storage media may include volatile and non-volatile, removable and non-removable media implemented in any method or technology. Computer-readable storage media includes, but is not limited to, RAM, ROM, erasable programmable ROM (EPROM), electrically-erasable programmable ROM (EEPROM), flash memory or other solid-state memory technology, compact disc ROM (CD-ROM), digital versatile disk (DVD), high definition DVD (HD-DVD), BLU-RAY, or other optical storage, magnetic cassettes, magnetic tape, magnetic disk storage or other magnetic storage devices, or any other medium that can be used to store the desired information in a non-transitory fashion.

The input/output controllers 206 for receiving and processing input from a number of input devices, such as a keyboard, a mouse, a touchpad, a touch screen, an electronic stylus, or other type of input device. Similarly, the input/output controller 206 may provide output to display 202, such as an e-Ink display, LED display, segmented display, OLED display, low-power display, or any suitable display device.

Solar cells 204 may be controlled through power management 214, and may include power storage such as batteries, capacitors, storage cells, and/or any combination thereof. Additionally, in some implementations, battery backup may be provided separate to the solar cells 204. Still further, solar cells 204 may be replaced or omitted entirely and a different source of power may be used. Other sources of power may include radio frequency antennae configured to receive power externally, batteries, low power transmission from a transformer, power transmission thorough a plug or connector, or any suitable source of power.

Sensors 210 may include sensors configured to detect moisture, water, temperature, and any other desirable parameter of the water cavity 120. For example, a hygrometer may be used to detect humidity levels, a PN-junction, thermistor, transistor, and/or thermocouple may be used to detect temperature, and other suitable devices may also be used. As sensing feedback is received through I/O controllers 206, data received from the sensors 210 is processed by CPUs 208 and a related display of the data (or related data) is provided for display at the display 202.

In this manner, moisture content and appropriate feedback is provided through the feedback components 110. It will be appreciated that the feedback components 110 may not include all of the components shown in FIG. 6, may include other components that are not explicitly shown in FIG. 6, or may utilize architecture completely different than that shown in FIG. 6.

As described above, a self-watering container can include an outer wall being substantially waterproof, an inner wall being substantially porous, the inner wall defining a growing medium cavity, and the inner wall and outer wall defining a cylindrical water cavity in hydraulic communication with the growing medium cavity, and a growing medium support mesh, the growing medium support mesh being configured to rest against the inner wall and receive moisture from the cylindrical water cavity through the substantially porous inner wall. Furthermore, the self-watering container may include feedback components configured to provide data related to a moisture content or water level of the water cavity. The data related to moisture content can further include temperature, humidity, and other suitable data. The water cavity is generally cylindrical and extends vertically from a base of the container to a rim of the container, where an aperture is provided for filling the water cavity. Additionally, clips or retention features may be used to hang or support the support mesh within the container.

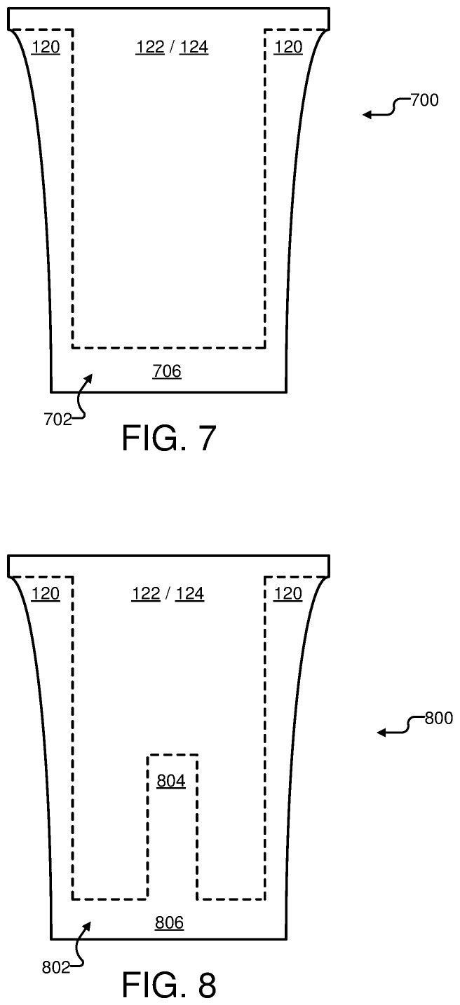

While these features have been described and illustrated in detail, it is appreciated that other variations exist. Hereinafter, example variations that may be utilized individually, or in combination, with any of the above features are presented with reference to FIGS. 7-13. It should be readily understood that these examples are non-limiting of all implementations, and may be used as options, combinations, alterations, and/or extensions of the above description. Furthermore, any component illustrated may be used in a different implementation, and any feature may be added or removed in different implementations.

FIG. 7 is a lateral cross section view of an alternative arrangement 700 of a self-watering container, in accordance with some implementations. As shown, an additional water reservoir 706 is provided in hydraulic communication with the water cavity 120. The additional water reservoir 706 may provide water access from a region 702 beneath the support mesh 130.

FIG. 8 is a lateral cross section view of an alternative arrangement 800 of a self-watering container, in accordance with some implementations. As shown, an additional water reservoir 806 is provided in hydraulic communication with the water cavity 120. A water column or porous column 804 may extend vertically from the region 802 into a central portion of the support mesh 130. In this arrangement, capillary action may vertically lift water through the porous water column 804 into the central portion of the support mesh 130 and/or growing medium. The column 804 may be formed of any suitable material, including ceramic, clay, plastic, glass, fiber, rope, and other suitably porous materials. Additionally, while the column 804 may bring water upwards into the growing medium, it may also allow drainage from the growing medium under some circumstances, thereby ensuring overwatering is reduced or minimized

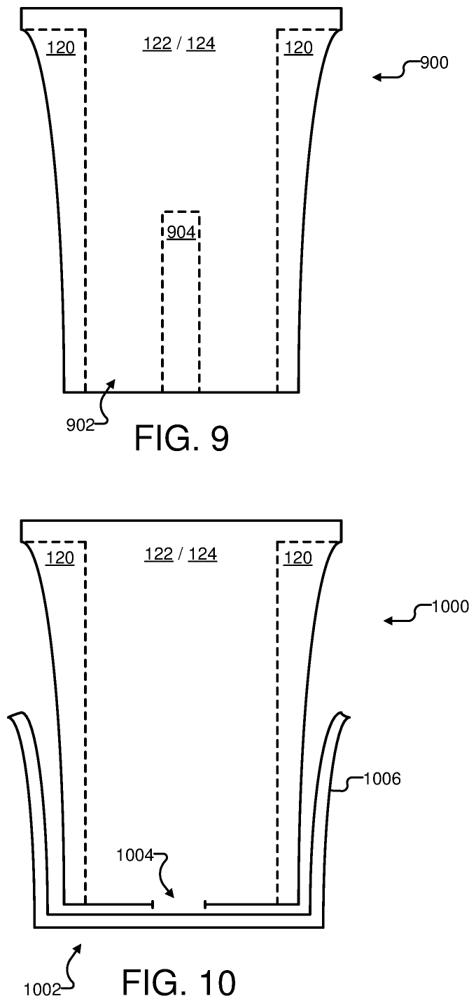

FIG. 9 is a lateral cross section view of an alternative arrangement 900 of a self-watering container, in accordance with some implementations. As shown, a column 904 is provided, similar in function to the column 804, while an additional water reservoir in the area 902 is omitted. Therefore, moisture from a bottom portion of the growing medium may be distributed evenly, and some additional drainage may also be provided such that water logging of roots is reduced or minimized Furthermore, additional aeration and oxygen access by the roots is supposed considering the arrangement of the column 904 and its porous composition.

FIG. 10 is a lateral cross section view of an alternative arrangement 1000 of a self-watering container, in accordance with some implementations. As shown, a central drainage aperture 1004 is provided to drain water into a dish or saucer 1006 that may be placed beneath the container. The sides of the dish 1006 may be any suitable height, and may include a base 1002 arranged to receive the container and support any drained water. Furthermore, the drainage aperture 1004 may also be used to provide access to previously drained water and/or provide additional water contained by the dish 1006.

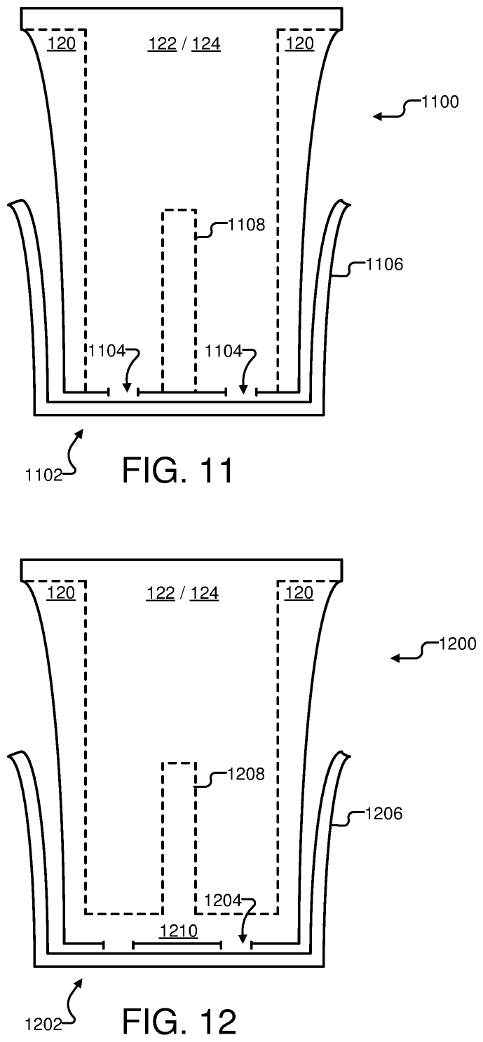

FIG. 11 is a lateral cross section view of an alternative arrangement 1100 of a self-watering container, in accordance with some implementations. As shown, a column 1108 that is substantially similar to columns 804/904 is provided. Furthermore, additional drainage aperture or apertures 1104 may be provided, as well as dish 1106 having a base 1102 for supporting drained water, additional water, and the container. The function of the apertures 1104 may be similar to aperture 1004. The function of the column 1108 may be similar to the columns 804/904.

FIG. 12 is a lateral cross section view of an alternative arrangement 1200 of a self-watering container, in accordance with some implementations. As shown, a column 1208 that is substantially similar to columns 804/904/1108 is provided. Furthermore, additional drainage aperture or apertures 1204 may be provided, as well as dish 1206 having a base 1202 for supporting drained water, additional water, and the container. The function of the apertures 1204 may be similar to aperture 1004 and aperture(s) 1104. The function of the column 1208 may be similar to the columns 804/904/1108. Moreover, an additional water reservoir 1210 beneath the growing medium and in hydraulic communication with the water cavity 120 may be provided.

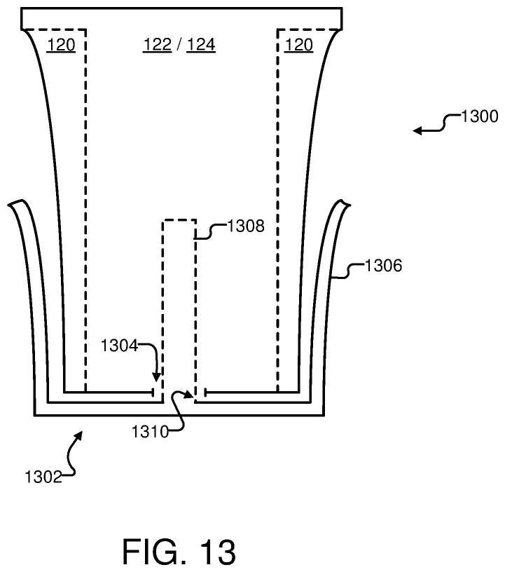

FIG. 13 is a lateral cross section view of an alternative arrangement 1300 of a self-watering container, in accordance with some implementations. As shown, a column 1308 that is substantially similar to columns 804/904 is provided. Furthermore, additional drainage aperture 1304 may be provided, as well as dish 1306 having a base 1302 for supporting drained water, additional water, and the container. As shown, the column 1308 may be attached or supported by the base 1302, rather than within the container. Accordingly, the column 1308 may extend vertically into the aperture 1304 allowing water to be brought vertically from the dish 1306 into the growing medium. The interface 1310 between the column 1308 and dish 1306 may include adhesive or other attachments. However, the column 1308 and dish 1306 may also be formed of a similar or the same material, such as ceramic, clay, stone, or another material.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A self-watering container, comprising:
an outer wall being substantially waterproof;
an inner wall being substantially porous, the inner wall defining a growing medium cavity, and the inner wall and outer wall defining a cylindrical water cavity in hydraulic communication with the growing medium cavity; and
a growing medium support mesh, the growing medium support mesh being configured to rest against the inner wall and receive moisture from the cylindrical water cavity through the substantially porous inner wall.

2. The self-watering container of claim 1, wherein the outer wall is formed of plastic or ceramic.

3. The self-watering container of claim 1, wherein the inner wall is formed of the same material as the outer wall.

4. The self-watering container of claim 1, wherein the inner wall is formed of a different material as the outer wall.

5. The self-watering container of claim 1, wherein the inner wall is formed of plastic or ceramic.

6. The self-watering container of claim 1, further comprising a base member, the base member defining a bottom portion of the growing medium cavity.

7. The self-watering container of claim 6, further comprising a central column formed on the base member.

8. The self-watering container of claim 7, wherein the central column is configured to be in hydraulic communication with the water cavity.

9. The self-watering container of claim 6, further comprising at least one aperture formed through the base member.

10. The self-watering container of claim 9, further comprising a saucer configured to catch water expelled through the at least one aperture.

11. A self-watering container, comprising:
a cylindrical outer wall being substantially waterproof;
a cylindrical inner wall being substantially porous, the cylindrical inner wall defining a growing medium cavity, and the cylindrical inner wall and cylindrical outer wall defining a cylindrical water cavity in hydraulic communication with the growing medium cavity; and
a growing medium support mesh, the growing medium support mesh being configured to rest against the cylindrical inner wall and receive moisture from the cylindrical water cavity through the substantially porous cylindrical inner wall.

12. The self-watering container of claim 11, wherein the cylindrical outer wall is formed of plastic.

13. The self-watering container of claim 11, wherein the cylindrical inner wall is formed of the same material as the cylindrical outer wall.

14. The self-watering container of claim 11, wherein the cylindrical inner wall is formed of a different material as the cylindrical outer wall.

15. The self-watering container of claim 11, wherein the cylindrical inner wall is formed of plastic.

16. The self-watering container of claim 11, further comprising a base member, the base member defining a circular bottom portion of the growing medium cavity.

17. The self-watering container of claim 16, further comprising a central column formed on the base member.

18. The self-watering container of claim 17, wherein the central column is configured to be in hydraulic communication with the water cavity.

19. The self-watering container of claim 16, further comprising at least one aperture formed through the base member.

20. The self-watering container of claim 19, further comprising a saucer configured to catch water expelled through the at least one aperture.
